(19) United States
(12) Patent Application Publication
(10) Pub. No.: US 2026/0331784 A1
(43) Pub. Date: Oct. 22, 2026

(54) RECONFIGURABLE ANTENNA DEVICE WITH A WAVEGUIDE STRUCTURE AND AT LEAST ONE METASURFACE

(71) Applicant: Novocomms Ltd., Birmingham (GB)

(72) Inventors: Zhenhua Hu, Birmingham (GB); Qingling Yang, Birmingham (GB)

(21) Appl. No.: 19/099,420

(22) PCT Filed: Jul. 27, 2023
(86) PCT No.: PCT/EP2023/070939

§ 371 Date: Jan. 28, 2025

(30) Foreign Application Priority Data
Jul. 29, 2022 (GB) 2211127.2
Sep. 28, 2022 (GB) 2214201.2
Feb. 20, 2023 (GB) 2302393.0

(51) Int. Cl. H01Q 21/00; H01Q 3/38; H01Q 3/44; H01Q 13/20; H01Q 15/00

(52) U.S. Cl. CPC H01Q 21/0043; H01Q 3/38; H01Q 3/443; H01Q 13/20; H01Q 15/002; H01Q 15/0086

(57) ABSTRACT

There is disclosed a reconfigurable antenna device including: i) at least one grounded waveguide structure comprising a metallic base wall and a metallic top wall substantially parallel to the base wall, and provided with a periodic pattern of apertures, the waveguide structure defining a substantially linear cavity with first and second ends; ii) an upper electromagnetic metasurface layer disposed over the metallic top wall, the upper electromagnetic metasurface layer comprising a series of elements configured to interact with and modify a property of RF energy passing through the upper electromagnetic metasurface layer; and iii) a first RF feed configured to input a first RF signal into the first end of the linear cavity.

This application is a national stage entry of WO International Patent Application No. PCT/EP2023/070939, filed 27 Jul. 2023, which claims the priority to GB Patent Application No. 2302393.0, filed 20 Feb. 2023, GB Patent Application No. 2214201.2, filed 28 Sep. 2022, and GB Patent Application No. 2211127.2, filed 29 Jul. 2022, the entire contents of each of these applications being incorporated herein by reference.

### TECHNICAL FIELD

This disclosure relates to a reconfigurable antenna device comprising a waveguide structure and at least one metasurface. The antenna device may be useful for beam steering applications.

### BACKGROUND

Mobile and telecommunications devices are becoming more complex and demanding in the way they use the available spectrum, especially in the bands between 10-300 GHz. These bands of spectrum are being utilised for the next-generation of mobile communications, known as 5G (fifth-generation) or 6G (sixth-generation), satellite communications and certain automobile radars used in in guidance, safety, and also automobile communications and entertainment systems. This spectrum has lots of demanding uses such as ability to support very fast services, increasing existing 4G bandwidth, and short-range effectiveness allowing frequency re-use, which all make increasing complexity on the control and operation of antennas in this regime.

Current antenna designs operating at these frequencies are required to utilise beam-steering capabilities to maximise the potential of such communications. Traditional methods of beam steering using antenna element arrays uses a technique called phased array. By adjusting the feeding phase of each antenna element and the constructive and destructive interference from each wavelet creates a steerable wavefront. However, such systems require complex phase-shifting electronics controls and feeding networks which increases the costs and complexity.

A newer technology for beam-steering uses what is known as a controllable reconfigurable metasurface. These devices use a metamaterial which is an artificial structure comprised of repeating unit cells arranged to provide particular properties. Such materials are already well known in photonics. Each unit cell of the metasurface can be reconfigured or structured to adjust properties of the emitted wave, this can be through passive structural type arrangements, or using components such as reconfigurable elements e.g. diodes, radio frequency (RF) switches, liquid crystals, graphene, or microelectromechanical elements (MEMs). This method is much more flexible, lower cost and lower power than traditional phase shifting techniques.

Although metasurface antenna arrays provide many advantages over traditional phased arrays, they still have some drawbacks. For example, they require a large number of reconfigurable components, and each of these reconfigurable components has to be addressed by some circuitry to operate. Implementations using liquid crystal technologies can make the antenna slow to beam steer, due to their slow response, and also have a potentially large footprint, depending on the preciseness of the beam steer required.

Another problem is that each unit cell of the metasurface needs to be synchronised with the others and also receive a signal at the same time. This can be challenging in large and complex metasurfaces, such as those required for satellite uplink especially.

Therefore, there is a requirement for a metasurface beam steering antenna that overcomes the described problems.

### SUMMARY

Viewed from a first aspect, a reconfigurable antenna device includes:
i) at least one grounded waveguide structure comprising a metallic base wall and a metallic top wall substantially parallel to the base wall, and provided with a periodic pattern of apertures, the waveguide structure defining a substantially linear cavity with first and second ends;
ii) an upper electromagnetic metasurface layer disposed over the metallic top wall, the upper electromagnetic metasurface layer comprising a series of elements configured to interact with and modify a property of RF energy passing through the upper electromagnetic metasurface layer; and
iii) a first RF feed configured to input a first RF signal into the first end of the linear cavity;
wherein the waveguide structure is configured to guide at least one RF travelling wave along the substantially linear cavity such that RF energy emanating through the apertures of the periodic pattern of apertures in the metallic top wall couples with the series of elements of the upper electromagnetic metasurface layer so as to modify the RF energy emanating through the apertures.

In contrast to the antenna devices of U.S. Pat. No. 10,587,042, the antenna devices of the present disclosure may include a linear, rather than cylindrical, geometry, and the RF feed may not have to pass through the metallic base wall.

The antenna device of the first aspect may further comprise a second RF feed configured to input a second RF signal into the second end of the linear cavity. In this way, two different RF signals may be fed into the linear cavity from different ends. This may facilitate multi-band operation of the antenna device.

The series of elements in the upper electromagnetic metasurface layer may be in registration with the periodic pattern of apertures in the top wall. This means that each element in the upper electromagnetic metasurface layer is disposed above or adjacent to a corresponding aperture in the top wall, for example in an overlapping arrangement when viewed from directly above.

The series of elements in the upper electromagnetic metasurface layer may comprises passive, non-reconfigurable conductive elements. The conductive elements may be connected to ground. The conductive elements may not be connected to ground. The conductive elements may be configured as floating conductive elements having a potential other than earth or chassis ground. The conductive elements may comprise conductive patch elements.

The series of elements in the upper electromagnetic metasurface layer may comprise active, reconfigurable elements. For example, the elements in the upper electromagnetic metasurface layer may comprise at least one of switchable conductive patches, switchable slots, microelectromechanical (MEMS) elements, nanoelectromechanical (NEMS) elements, chiral change elements, and liquid crystal elements. The active, reconfigurable elements may be configured to be switchable between at least a first state and a second state, the first state interacting with and modifying the RF energy differently to the second state.

The antenna device may further comprise control circuitry to reconfigure the active, reconfigurable elements of the upper electromagnetic metasurface layer so as controllably to modify RF energy passing through the upper electromagnetic metasurface layer from the apertures in the top wall of the substantially linear waveguide. For example, the control circuitry may apply a bias voltage or bias current that can selectively be switched on or off for selected active elements in order to switch the selected active elements from the first state to the second state or from the second state to the first state. The active elements may be individually switched by the control circuitry, or may be switched together in groups.

The active, reconfigurable elements of the upper electromagnetic metasurface layer may each comprise a conductive patch and a switchable component connecting the conductive patch to ground. This may enable enables switching between a first state and a second state by way of selectively connecting the conductive patch to ground or disconnecting the conductive patch from ground. The switchable component may be selected from the group consisting of: diodes, semiconductor diodes, PIN diodes, MEMS devices, NEMS devices, varactors, varicap diodes, varactor diodes, tuning diodes, liquid crystal switches, liquid metal switches, and phase change material switches.

The antenna device may further comprise a lower electromagnetic metasurface layer disposed on or adjacent to the base wall within the substantially linear cavity, the lower electromagnetic metasurface layer comprising a series of elements configured to interact with and modify a property of RF energy incident upon and reflected by the lower electromagnetic metasurface layer.

Viewed from a second aspect, a reconfigurable antenna device includes:
i) at least one grounded waveguide structure comprising a metallic base wall and a metallic top wall substantially parallel to the base wall, and provided with a periodic pattern of apertures, the waveguide structure defining a substantially linear cavity with first and second ends;
ii) an upper electromagnetic metasurface layer disposed over the metallic top wall, the upper electromagnetic metasurface layer comprising a series of elements configured to interact with and modify a property of RF energy passing through the upper electromagnetic metasurface layer;
iii) a lower electromagnetic metasurface layer disposed on or adjacent to the base wall within the substantially linear cavity, the lower electromagnetic metasurface layer comprising a series of elements configured to interact with and modify a property of RF energy incident upon and reflected by the lower electromagnetic metasurface layer; and
iv) a first RF feed configured to input a first RF signal into the first end of the linear cavity;
wherein the waveguide structure is configured to guide at least one RF travelling wave along the substantially linear cavity such that RF energy emanating through the apertures of the periodic pattern of apertures in the metallic top wall couples with the series of elements of the upper electromagnetic metasurface layer so as to modify the RF energy emanating through the apertures, and wherein the waveguide structure is configured to guide at least one RF travelling wave along the substantially linear cavity such that RF energy incident upon the lower electromagnetic metasurface layer interacts with and is modified by the series of elements and reflected towards and through the apertures in the top wall of the substantially linear waveguide.

The antenna device of the second aspect may further comprise a second RF feed configured to input a second RF signal into the second end of the linear cavity. In this way, two different RF signals may be fed into the linear cavity from different ends. This may facilitate multi-band operation of the antenna device.

The series of elements in the lower electromagnetic metasurface layer may be in registration with the periodic pattern of apertures in the top wall. This means that each element in the lower electromagnetic metasurface layer is disposed under a corresponding aperture in the top wall, on the bottom of the linear cavity, for example in an overlapping arrangement when viewed from directly above.

The series of elements in the lower electromagnetic metasurface layer may comprise passive, non-reconfigurable conductive elements. The conductive elements may be connected to ground. The conductive elements may not be connected to ground. The conductive elements may be configured as floating conductive elements having a potential other than earth or chassis ground. The conductive elements may comprise conductive patch elements.

The series of elements in the lower electromagnetic metasurface layer may comprise active, reconfigurable elements. For example, the elements in the lower electromagnetic metasurface layer may comprise at least one of switchable conductive patches, switchable slots, microelectromechanical (MEMS) elements, nanoelectromechanical (NEMS) elements, chiral change elements, and liquid crystal elements. The active, reconfigurable elements may be configured to be switchable between at least a first state and a second state, the first state interacting with and modifying the RF energy differently to the second state.

The antenna device may further comprise control circuitry to reconfigure the active, reconfigurable elements of the lower electromagnetic metasurface layer so as controllably to modify RF energy incident upon the lower electromagnetic metasurface layer and reflected towards the apertures in the top wall of the substantially linear waveguide. For example, the control circuitry may apply a bias voltage or bias current that can selectively be switched on or off for selected active elements in order to switch the selected active elements from the first state to the second state or from the second state to the first state. The active elements may be individually switched by the control circuitry, or may be switched together in groups.

The upper electromagnetic metasurface layer and the lower electromagnetic metasurface layer may be controlled by the same control circuitry. The upper electromagnetic metasurface layer and the lower electromagnetic metasurface layer may be controlled by different control circuitries.

The active, reconfigurable elements of the lower electromagnetic metasurface layer may each comprise a conductive patch and a switchable component connecting the conductive patch to ground. This enables switching between a first state and a second state by way of selectively connecting the conductive patch to ground or disconnecting the conductive patch from ground. The switchable component may be selected from the group consisting of: diodes, semiconductor diodes, PIN diodes, MEMS devices, NEMS devices, varactors, varicap diodes, varactor diodes, tuning diodes, liquid crystal switches, liquid metal switches, and phase change material switches.

Viewed from a third aspect, a reconfigurable antenna device includes:
i) at least one grounded waveguide structure comprising a metallic base wall and a metallic top wall substantially parallel to the base wall, and provided with a periodic pattern of apertures, the waveguide structure defining a substantially linear cavity with first and second ends;
ii) a lower electromagnetic metasurface layer disposed on or adjacent to the base wall within the substantially linear cavity, the lower electromagnetic metasurface layer comprising a series of elements configured to interact with and modify a property of RF energy incident upon and reflected by the lower electromagnetic metasurface layer; and
iii) a first RF feed configured to input a first RF signal into the first end of the linear cavity;
wherein the waveguide structure is configured to guide at least one RF travelling wave along the substantially linear cavity such that RF energy incident upon the lower electromagnetic metasurface layer interacts with and is modified by the series of elements and reflected towards and through the apertures in the top wall of the substantially linear waveguide.

The antenna device of the third aspect may further comprise a second RF feed configured to input a second RF signal into the second end of the linear cavity. In this way, two different RF signals may be fed into the linear cavity from different ends. This may facilitate multi-band operation of the antenna device.

The series of elements in the lower electromagnetic metasurface layer may be in registration with the periodic pattern of apertures in the top wall. This means that each element in the lower electromagnetic metasurface layer is disposed under a corresponding aperture in the top wall, on the bottom of the linear cavity, for example in an overlapping arrangement when viewed from directly above.

The series of elements in the lower electromagnetic metasurface layer may comprise passive, non-reconfigurable conductive elements. The conductive elements may be connected to ground. The conductive elements may not be connected to ground. The conductive elements may be configured as floating conductive elements having a potential other than earth or chassis ground. The conductive elements may comprise conductive patch elements.

The series of elements in the lower electromagnetic metasurface layer may comprise active, reconfigurable elements. For example, the elements in the lower electromagnetic metasurface layer may comprise at least one of switchable conductive patches, switchable slots, microelectromechanical (MEMS) elements, nanoelectromechanical (NEMS) elements, chiral change elements, and liquid crystal elements. The active, reconfigurable elements may be configured to be switchable between at least a first state and a second state, the first state interacting with and modifying the RF energy differently to the second state.

The antenna device may further comprise control circuitry to reconfigure the active, reconfigurable elements of the lower electromagnetic metasurface layer so as controllably to modify RF energy incident upon the lower electromagnetic metasurface layer and reflected towards the apertures in the top wall of the substantially linear waveguide. For example, the control circuitry may apply a bias voltage or bias current that can selectively be switched on or off for selected active elements in order to switch the selected active elements from the first state to the second state or from the second state to the first state. The active elements may be individually switched by the control circuitry, or may be switched together in groups.

The active, reconfigurable elements of the lower electromagnetic metasurface layer may each comprise a conductive patch and a switchable component connecting the conductive patch to ground. This enables switching between a first state and a second state by way of selectively connecting the conductive patch to ground or disconnecting the conductive patch from ground. The switchable component may be selected from the group consisting of: diodes, semiconductor diodes, PIN diodes, MEMS devices, NEMS devices, varactors, varicap diodes, varactor diodes, tuning diodes, liquid crystal switches, liquid metal switches, and phase change material switches.

In all of the aspects outlined above, the modification of the RF energy may comprise polarisation modification. For example, a polarisation angle or a polarisation direction may be modified. For example, linear polarisation may be modified to circular polarisation. For example, left-handed circular polarisation may be modified to right-handed circular polarisation. The desired modification is determined by the elements of the upper and/or the lower electromagnetic metasurface layer(s).

In all of the aspects outlined above, the modification of the RF energy comprises phase modification. Different phase shifts may be applied to an RF signal by different elements of the upper and/or the lower electromagnetic metasurface layers, for example by appropriate control of active, reconfigurable elements. This may facilitate beam steering.

The antenna device of any of the aspects outlined above may comprise a plurality of grounded waveguide structures arranged adjacent and substantially parallel to each other. This may allow a two dimensional array of apertures to be defined at the metallic top walls of the antenna device. Each waveguide structure may have its own metallic top wall with a linear series of apertures, or a common metallic top wall structure with a two dimensional array of apertures may be provided.

The linear waveguide structure may comprise a plurality of repeated unit cells arranged end-to-end. Each unit cell may comprise a portion of the top wall having an aperture. Each unit cell may comprise an element of at least one of the upper electromagnetic metasurface layer and the lower electromagnetic metasurface layer. The unit cells may be disposed so as to form a linear one dimensional array. The unit cells may be disposed so as to form two dimensional array.

The at least one grounded waveguide structure may further comprise a metallic end wall at the first end of the substantially linear cavity. The at least one grounded waveguide structure may further comprise a metallic end wall at the second end of the substantially linear cavity.

The first RF feed may be disposed between the top wall and the base wall. This may avoid the need to pass the feed through one or other of the metallic top wall or metallic bottom wall, and can reduce RF losses. Likewise, the second RF feed (where provided) may be disposed between the top wall and the base wall.

The apertures in the top wall may be formed as slots. The slots may be angled to a longitudinal axis of the linear cavity at an angle other than 0 degrees or 90 degrees. The slots may all have angled by the same angle. The slots may be angled at different angles. The slots may all have the same length. The slots may all have the same width. The slots may have different lengths. The slots may have different widths.

The grounded waveguide structure may further comprise first and second substantially parallel metallic side walls that disposed substantially perpendicular to the base wall and the top wall. This may help to reduce unwanted leakage of RF energy out of the sides of the waveguide structure.

The first and second substantially parallel metallic side walls may have a height, h, and a mutual separation distance, d.

In some embodiments h>d, optionally h>2d, optionally h>3d, optionally h>4d. These waveguide structures may be considered to be narrow wall waveguides.

In some embodiments, d>h, optionally d>2h, optionally d>3d, optionally d>4d. In some of these embodiments, d<10h. These waveguide structures may be considered to be broad wall waveguides.

In some embodiments, d>20h, optionally d>20h and d<100h, optionally d>20h and d<500h. These waveguide structures may be considered to be parallel plane waveguides.

The linear waveguide structure may be filled with air. Air is less RF lossy than solid or foam dielectric structures that are used in prior art devices, and may allow for more efficient operation.

The linear waveguide structure may be filled with a low-loss dielectric. Low-loss materials may allow for more efficient operation than conventional dielectric materials.

In some embodiments, the linear waveguide structure is not filled with any solid or liquid dielectric material. Solid or liquid dielectric materials may introduce unwanted RF losses.

In the context of the present disclosure, the term “electromagnetic metasurface layer” is intended to mean a layer of structured or engineered material comprising a series of elements disposed on or in the layer that are sized and configured to interacts with electromagnetic waves that pass through the layer or that are incident upon and reflected by the layer. Specifically, the electromagnetic metasurface layers employed in the present disclosure are configured for use with RF waves, which typically have a wavelength of the order of centimetres or millimetres. Electromagnetic metasurfaces typically have a subwavelength thickness. The elements disposed on or in the layer should be sized or shaped or sized and shaped with dimensions of a similar order of magnitude to the wavelength of the RF waves, or a smaller order of magnitude to the wavelength of the RF waves. The elements may be arranged with a regular periodicity. The elements may be arranged with an irregular periodicity. The elements may be arranged with a random periodicity. The periodicity should also be of a similar order of magnitude to the wavelength of the RF waves, or a smaller order of magnitude to the wavelength of the RF waves. A one dimensional electromagnetic metasurface layer may comprise a one dimensional linear array or series of elements. A two dimensional electromagnetic metasurface layer may comprise a two dimensional array or series of elements. The elements may take various forms, and may, for example, comprise electrically conductive patches or tracks, which may be printed or etched on a dielectric substrate, or may be formed by laser direct structuring or other techniques.

In some embodiments, the reconfigurable antenna device may be configured as a leaky-wave antenna. In some embodiments, the reconfigurable antenna device may be configured more generally as a travelling wave antenna.

### BRIEF DESCRIPTION OF THE DRAWINGS

Embodiments of the invention are further described hereinafter with reference to the accompanying drawings.

FIG. 1a shows a metasurface antenna arrangement according to U.S. Pat. No. 10,587,042.

FIG. 1b shows another metasurface antenna arrangement according to U.S. Pat. No. 10,587,042.

FIG. 2 shows a metasurface antenna arrangement according to the Fabry-Perot document.

FIG. 3 shows a cross-sectional view of a metasurface antenna according to a first embodiment of the present disclosure.

FIG. 4 shows a cross-sectional view of a metasurface antenna according to a second embodiment of the present disclosure.

FIG. 5 shows a perspective view of the embodiment of FIG. 3.

FIG. 6 shows the simulated radiating efficiency against frequency for the embodiment of FIGS. 3 and 5.

FIG. 7 shows a perspective view of the embodiment of FIG. 4.

FIG. 8 shows the simulated radiating efficiency against frequency for the embodiment of FIGS. 4 and 7.

FIG. 9 shows a cross-sectional view of a metasurface antenna according to a third embodiment of the present disclosure.

FIG. 10 shows a simulated radiation pattern showing beam steering using the embodiment of FIGS. 3 and 4.

FIG. 11 shows a cross-sectional view of a metasurface antenna according to a third embodiment of the present disclosure.

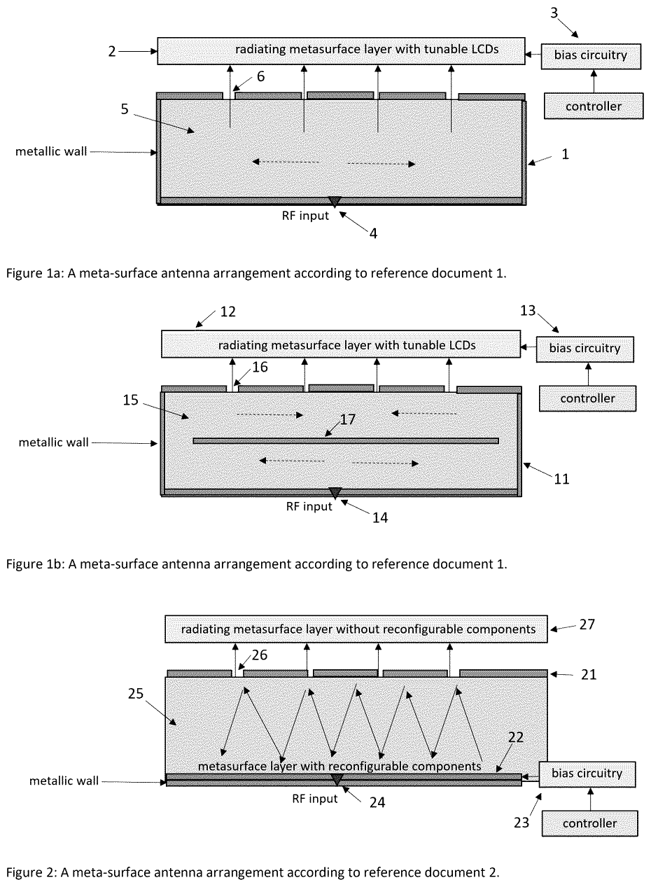

### DETAILED DESCRIPTION

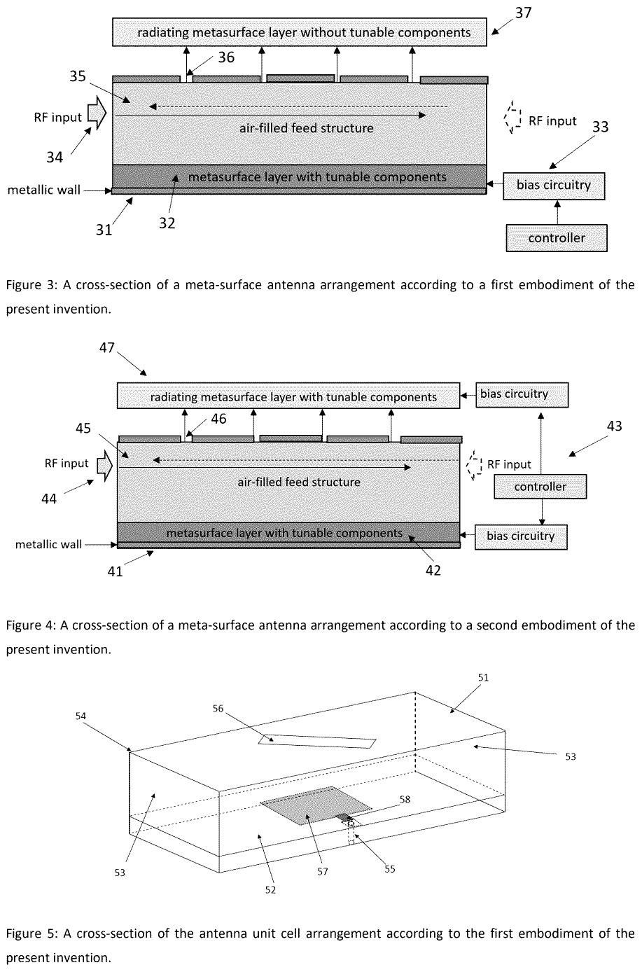

A first embodiment of the present disclosure is schematically illustrated in FIG. 3 which shows a cross-sectional view of the proposed antenna structure. The structure comprises upper and lower metal substrates 31 (metallic top wall and metallic base wall) with the top substrate having apertures or slots 36. The lower metal substrate is provided with an electromagnetic metasurface layer 32 made up from reconfigurable unit cells and controlled by circuitry 33.

A linear cavity 35 is fed from one end with a first RF feed 34 and is air-filled to help reduce losses. The feed structure of the first RF feed 34 is located above the reconfigurable metasurface layer 32, and this reduces complexity of control and bias circuitry elements. The opposing side to the feed is closed to form a travelling-wave waveguide in the linear cavity 35. It should be noted that in this view (cross-section) the side walls are omitted for clarity. The structure will form a closed air-filled waveguide with the metallic top wall, base wall and side walls forming the ground plane. It should also be noted that in some embodiments both sides of the antenna waveguide can be fed to support multi-band operation.

A travelling wave is set up which traverses the cavity 35 and when configured with the slots or apertures 36, the arrangement may behave as a leaky-wave antenna. Leaky-wave antennas are a special class of travelling wave antenna that use a travelling wave on a guiding structure as the radiating source. Radiation can be invoked by a continuous slit along the waveguide, or through localised changes in the waveguide structure. Such changes can be invoked by apertures or reconfigurable components placed in the waveguide.

The properties of using a travelling wave in an air-filled waveguide structure and utilising the leak-wave radiation may enable much lower losses than the cited prior art documents in this frequency regime.

The reconfigurable metasurface 32 can alter the field inside the waveguide or the coupling to the radiating aperture and therefore realise phase or polarisation changes, allowing beam steering and polarisation control. This utilises the reconfigurability of the metasurface to alter the properties of the leaky-wave radiation at certain points to create radiation at certain slots or apertures 36.

A second passive metasurface 37 is configured at the top of the antenna arrangement. This has a surface that has unit cells with passive elements or structures to modify the radiated or incident waves. This can be achieved through coupling with the waves leaked from the cavity, absorbing or re-radiating some of the radio frequency energy or causing reflections or modify other properties of the wave such as phase or polarisation using the unit cell structures. This surface can enhance the operating bandwidth and radiation performance.

A second embodiment illustrated schematically in FIG. 4 comprises a similar cavity structure with upper and lower metal substrates 41 (metallic top wall and metallic base wall), the top layer having apertures or slots 46, and a feed from one side by way of RF feed 44, with the opposing side being closed to form a waveguide. In some variations, the linear cavity 45 may be open at both ends and have an RF feed 44 at both ends. The lower metal substrate is provided with a reconfigurable metasurface 42 arranged above it, and there is also a second reconfigurable metasurface 47 arranged above the slotted top metal substrate. Both reconfigurable metasurfaces 42, 47 are configured to be controlled through control and bias circuitry 43.

The upper reconfigurable metasurface layer 47 is configured to able to tune the antenna properties for a particular frequency band while the lower reconfigurable metasurface layer 42 is able to tune the antenna properties for operation at a second frequency band independently, due to the fact that the reconfigurable metasurface layers 42, 47 are positioned above and below the radio frequency feed 44.

As previously stated, this arrangement is lower loss due to the air-filled waveguide and the use of the leaky-wave or travelling wave regime rather than standing waves. Additionally, this arrangement may reduce the overall size and structural complexity by using the same reconfigurable aperture for both receive and radiating frequency tunability. The reconfigurable elements used for the active metasurface layer can be semiconductor RF diodes which have response times of around several nanoseconds; this gives a speed advantage over the prior art which employs liquid crystal technology having a response time of higher than 10 microseconds.

Preferred embodiments of the present disclosure do not use partially reflective metasurfaces as required in the Fabry-Perot document to form the Fabry-Perot resonating cavity. Use of partially-reflecting metasurfaces may impact the total efficiency of the antenna. Embodiments of the present disclosure may also overcome this problem by the use of a travelling wave with leaky-wave radiation.

FIG. 5 illustrates an arrangement of a reconfigurable unit cell that could be used in the first embodiment of the present invention. The unit cell has an upper 51 metallic layer with an aperture or slot 56, metallic sidewalls 53, and a lower metallic layer 52 that has the reconfigurable diode component 58 cooperating with a metallic patch 57 situated above the lower metallic layer. A conductive via 55 links the diode to respective matching and addressing circuitry below the unit cell structure. These unit cells can be arranged in a 1-dimensional strip, or multiple 1-dimensional strips forming a 2-dimensional array to cover the bottom of the lower metallic plate of the waveguide. In this embodiment, the unit cell always has an open end (called the feed for purposes of discussing the unit cell) with which the feed travelling wave can enter and if mid-array, a second open end for the wave to continue to the next unit cell. The unit cell may have metallic walls 53 on the sides running parallel with the travelling wave to create the closed waveguiding structure with the air-filled cavity, however this is defined by how the feeding is arrange over the array. The sidewalls, in some configurations, with different feeding arrangement, may not be necessary.

It should be noted that the top passive metasurface layer has been omitted from FIG. 5 to concentrate on the reconfigurable unit cell. The travelling wave emanates from the feed port 54 and is forced to radiate via the leaky-wave phenomenon by the change in cavity structure caused by the slot and the wave properties can be controlled by the switching state of the diode 58. The diode determines if the patch 57 is floating or grounded to the lower metallic layer. The patch may not simply be a square patch but could have other features such as reflective or parasitic elements in the vicinity, as are required by the properties the metasurface has to generate. This reconfiguration changes the propagation properties and therefore forces radiation towards the slot.

The radiating slot is configured at an optimal angle relative to the direction of the feed travelling wave. This angle may be important as it can affect both the radiating efficiency and the polarisation of the radiated wave. Therefore, arrangements of a 1-d array of unit cells according to this embodiment may have all slots arranged at the same angle, or the angle may change over the length of the 1-d array. Equally, arranging lengths of 1-d arrays of unit cells together to form a 2-d array may also have all slots configured at the same angle, or may have the slots at various angles dependent on the requirements of what the properties of the radiated wave are required to be.

To give a sense of scale of the unit cell described in the current embodiment, the width of the waveguide walls may be approximately 10 mm, the width and length of the patch around 2 mm, and the length of the slot around 3.5 mm. However, this indication of dimensionality should be not interpreted literally as the unit cell of an array changes for the required radiating frequency and therefore these dimensions will expand or shrink accordingly.

Another important aspect that should be noted is that the top passive metasurface unit cell should line up and be configured to cooperate to receive the emanated radiation from the slot of the bottom reconfigurable meta-surface unit cell.

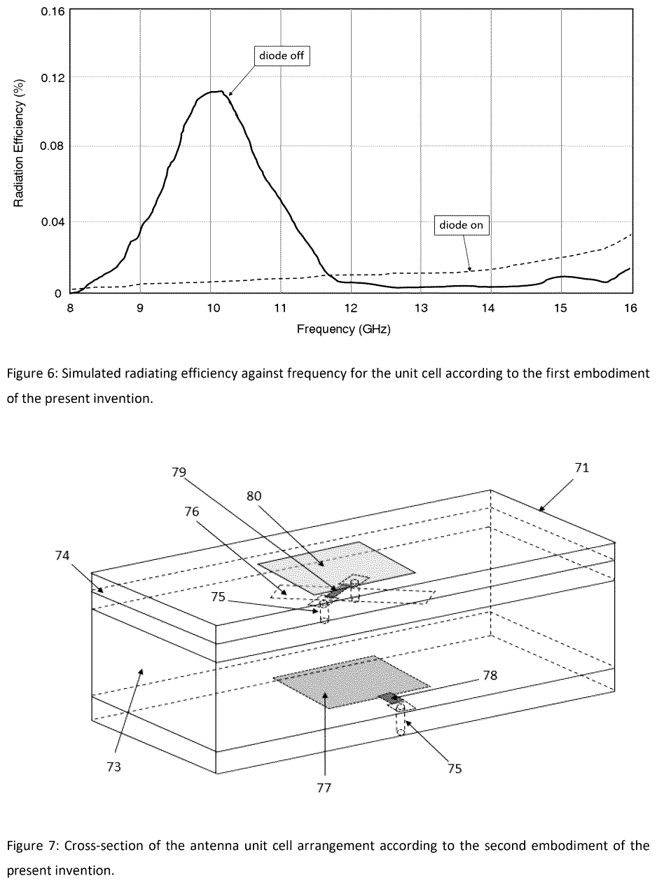

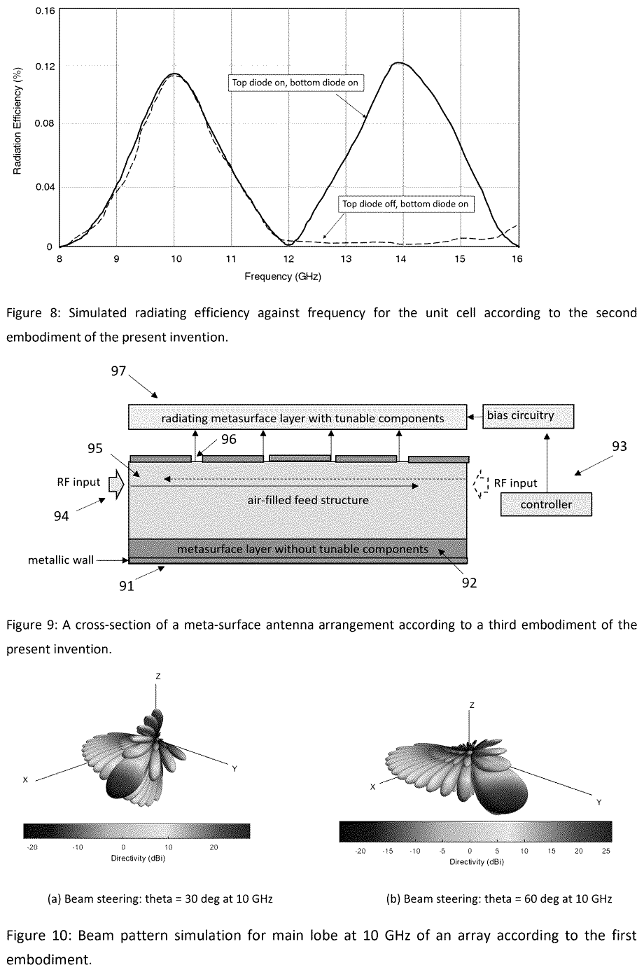

FIG. 6 shows a simulated radiation efficiency plot for one unit cell according to the first embodiment. It can be clearly seen that when the diode is switched “on”, such that the patch is grounded, there is no radiation. In the state where the diode is switched “off”, and the patch is not grounded, or is floating, results in a change in the physical parameters of the waveguide, leading to a leaky-wave radiation at, for this particular example, 10 GHz.

FIG. 7 shows a perspective view of the antenna unit cell according to the second embodiment. The unit cell comprises a lower metal substrate 72, an upper metal substrate 71, and metal sidewalls 73 which are configured to be on parallel sides to the incidence of the feed or travelling wave 74. On the bottom metal substrate is the reconfigurable element of the metal patch 77 with the associated semiconductor diode 78, being configured to force a leaky-wave from the slot 76 in the upper metal substrate 71. Another reconfigurable unit cell comprises the slot 76, a semiconductor diode arranged on a layer 79, and a metal patch 80. The diode is configured on a planar structure which could be a metal patch situated between the slot and the radiating patch 80. A conductive via 75 links the diode to respective matching and addressing circuitry, or a ground, below the unit cell structure on the bottom layer, or could be an intermediate layer below the top unit cell. The extra reconfigurable layer creates the second metasurface when the unit cells are correctly aligned with the first metasurface and arrayed suitably. Therefore, this arrangement has simultaneous control of incident and radiated waves in different frequency regimes to impart properties such as beam steer or polarisation.

FIG. 9 shows a cross-sectional view of a third embodiment of the present disclosure. This arrangement is similar to the first embodiment with upper and lower metal substrates 91, the upper layer having slots or apertures 96, and RF feed from one, or both ends 94 to create a travelling wave 95. A passive metasurface is located on the lower metal substrate 92 and the active reconfigurable metasurface is now located above the slotted layer 96, controlled by control circuitry 93. Beam steering in this arrangement is created by changing the states of the top metasurface via the tuneable components. The benefits of this particular arrangement are enhanced bandwidth and extended beam scan range (up to +/−70 degrees).

FIG. 10 shows a simulated radiation pattern at two different angles (30 degrees and 60 degrees) for the first embodiment of the present invention. The simulation used an array of 3600 unit cells (60×60) with the antenna aperture in the Y-Z plane and shows the main lobe in shades of red (darker shades) radiating upwards from the aperture plane. FIG. 10 clearly shows that the main lobe is able to be steered.

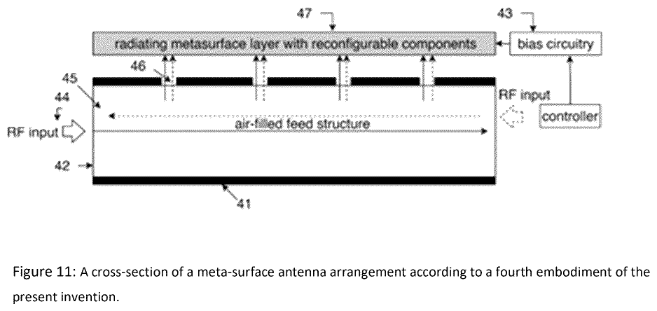

A third embodiment illustrated schematically in FIG. 11 comprises a similar cavity structure with upper and lower metal substrates 41 (metallic top wall and metallic base wall), the top layer having apertures or slots 46, and a feed from one side by way of RF feed 44, with the opposing side being closed to form a waveguide. In some variations, the linear cavity 45 may be open at both ends and have an RF feed 44 at both ends. The lower metal substrate does not have a metasurface. A reconfigurable metasurface 47 is provided above the slotted top metal substrate. The metasurface 47 is configured to be controlled through control and bias circuitry 43. The upper reconfigurable metasurface layer 47 is configured to able to tune the antenna properties for a particular frequency band.

It should be noted that in all embodiments the description of the waveguide structural walls and layers and also the patch elements as metal, however, these could be metal on printed circuit board, folded or pressed metal sheet, or even conductive traces on flexible carrier adhered to a suitably structed substrate. The unit cells described herein for the purposes of explaining the invention are simplistic and form box-type waveguides, however they could be more complex shapes, using the walls to impart further properties onto the wave.

Similarly, the use of a semiconductor diode as the reconfigurable element is purely exemplary, this could also include RF switches with biasing networks, or other reconfigurable component capable of producing the required change in wave or physical waveguide property that is desired. The slots or apertures may also not necessarily by rectangular in shape and could have curved edges, circular or a meander type slot.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A reconfigurable antenna device comprising:
at least one grounded waveguide structure comprising a metallic base wall and a metallic top wall substantially parallel to the base wall, and provided with a periodic pattern of apertures, the waveguide structure defining a substantially linear cavity with first and second ends;
an upper electromagnetic metasurface layer disposed over the metallic top wall, the upper electromagnetic metasurface layer comprising a series of elements configured to interact with and modify a property of RF energy passing through the upper electromagnetic metasurface layer;
a lower electromagnetic metasurface layer disposed on or adjacent to the base wall within the substantially linear cavity, the lower electromagnetic metasurface layer comprising a series of elements configured to interact with and modify a property of RF energy incident upon and reflected by the lower electromagnetic metasurface layer; and
a first RF feed configured to input a first RF signal into the first end of the linear cavity;
wherein the waveguide structure is configured to guide at least one RF travelling wave along the substantially linear cavity such that RF energy emanating through the apertures of the periodic pattern of apertures in the metallic top wall couples with the series of elements of the upper electromagnetic metasurface layer so as to modify the RF energy emanating through the apertures.

2. The antenna device of claim 1, further comprising a second RF feed configured to input a second RF signal into the second end of the linear cavity.

3. The antenna device of claim 1, wherein the series of elements in the upper electromagnetic metasurface layer is in registration with the periodic pattern of apertures in the top wall.

4. The antenna device of claim 1, wherein the series of elements in the upper electromagnetic metasurface layer comprises passive, non-reconfigurable conductive elements.

5. The antenna device of claim 1, wherein the series of elements in the upper electromagnetic metasurface layer comprises active, reconfigurable elements.

6. The antenna device of claim 5, wherein the elements in the upper electromagnetic metasurface layer comprise at least one of switchable conductive patches, switchable slots, microelectromechanical (MEMS) elements, nanoelectromechanical (NEMS) elements, chiral change elements, and liquid crystal elements.

7. The antenna device of claim 5, wherein the active, reconfigurable elements are configured to be switchable between at least a first state and a second state, the first state interacting with and modifying the RF energy differently to the second state.

8. The antenna device of claim 5, further comprising control circuitry to reconfigure the active, reconfigurable elements of the upper electromagnetic metasurface layer so as controllably to modify RF energy passing through the upper electromagnetic metasurface layer from the apertures in the top wall of the substantially linear waveguide.

9. The antenna device of claim 5, wherein the active, reconfigurable elements each comprise a conductive patch and a switchable component connecting the conductive patch to ground.

10. The antenna device of claim 9, wherein the switchable component is selected from the group consisting of: diodes, semiconductor diodes, PIN diodes, MEMS devices, NEMS devices, varactors, varicap diodes, varactor diodes, tuning diodes, liquid crystal switches, liquid metal switches, and phase change material switches.

11. (canceled)

12. A reconfigurable antenna device comprising:
at least one grounded waveguide structure comprising a metallic base wall and a metallic top wall substantially parallel to the base wall, and provided with a periodic pattern of apertures, the waveguide structure defining a substantially linear cavity with first and second ends;
an upper electromagnetic metasurface layer disposed over the metallic top wall, the upper electromagnetic metasurface layer comprising a series of elements configured to interact with and modify a property of RF energy passing through the upper electromagnetic metasurface layer;
a lower electromagnetic metasurface layer disposed on or adjacent to the base wall within the substantially linear cavity, the lower electromagnetic metasurface layer comprising a series of elements configured to interact with and modify a property of RF energy incident upon and reflected by the lower electromagnetic metasurface layer; and
a first RF feed configured to input a first RF signal into the first end of the linear cavity,
wherein the waveguide structure is configured to guide at least one RF travelling wave along the substantially linear cavity such that RF energy emanating through the apertures of the periodic pattern of apertures in the metallic top wall couples with the series of elements of the upper electromagnetic metasurface layer so as to modify the RF energy emanating through the apertures, and wherein the waveguide structure is configured to guide at least one RF travelling wave along the substantially linear cavity such that RF energy incident upon the lower electromagnetic metasurface layer interacts with and is modified by the series of elements and reflected towards and through the apertures in the top wall of the substantially linear waveguide.

13. (canceled)

14. The antenna device of claim 12, wherein the series of elements in the lower electromagnetic metasurface layer is in registration with the periodic pattern of apertures in the top wall.

15. The antenna device of claim 12, wherein the series of elements in the lower electromagnetic metasurface layer comprises passive, non-reconfigurable conductive elements.

16. The antenna device of claim 12, wherein the series of elements in the lower electromagnetic metasurface layer comprises active, reconfigurable elements.

17. The antenna device of claim 16, wherein the elements in the lower electromagnetic metasurface layer comprise at least one of switchable conductive patches, switchable slots, microelectromechanical (MEMS) elements, nanoelectromechanical (NEMS) elements, chiral change elements, and liquid crystal elements.

18. The antenna device of claim 16, wherein the active, reconfigurable elements are configured to be switchable between at least a first state and a second state, the first state interacting with and modifying the RF energy differently to the second state.

19. The antenna device of claim 16, further comprising control circuitry to reconfigure the active, reconfigurable elements of the lower electromagnetic metasurface layer so as controllably to modify RF energy incident upon the lower electromagnetic metasurface layer and reflected towards the apertures in the top wall of the substantially linear waveguide.

20. (canceled)

21. (canceled)

22. A reconfigurable antenna device comprising:
at least one grounded waveguide structure comprising a metallic base wall and a metallic top wall substantially parallel to the base wall, and provided with a periodic pattern of apertures, the waveguide structure defining a substantially linear cavity with first and second ends;
a lower electromagnetic metasurface layer disposed on or adjacent to the base wall within the substantially linear cavity, the lower electromagnetic metasurface layer comprising a series of elements configured to interact with and modify a property of RF energy incident upon and reflected by the lower electromagnetic metasurface layer; and
a first RF feed configured to input a first RF signal into the first end of the linear cavity;
wherein the waveguide structure is configured to guide at least one RF travelling wave along the substantially linear cavity such that RF energy incident upon the lower electromagnetic metasurface layer interacts with and is modified by the series of elements and reflected towards and through the apertures in the top wall of the substantially linear waveguide.

23-52. (canceled)

53. The antenna device of claim 16, wherein the active, reconfigurable elements each comprise a conductive patch and a switchable component connecting the conductive patch to ground.

54. The antenna device of claim 53, wherein the switchable component is selected from the group consisting of: diodes, semiconductor diodes, PIN diodes, MEMS devices, NEMS devices, varactors, varicap diodes, varactor diodes, tuning diodes, liquid crystal switches, liquid metal switches, and phase change material switches.

55. The antenna device of claim 22, further comprising a second RF feed configured to input a second RF signal into the second end of the linear cavity.

56. The antenna device of claim 22, wherein the series of elements in the lower electromagnetic metasurface layer comprises passive, non-reconfigurable conductive elements.
